(19) United States
(12) Patent Application Publication
(10) Pub. No.: US 2015/0106828 A1
(43) Pub. Date: Apr. 16, 2015

(54) METHOD AND APPARATUS FOR IDENTIFYING POINT OF INTEREST AND INSERTING ACCOMPANYING INFORMATION INTO A MULTIMEDIA SIGNAL

(71) Applicants: Gal Gubesi, Alfe Menashe (IL); Elran Ahronee, Alfe Menashe (IL); Gal Sont, Alfe Menashe (IL)

(72) Inventors: Gal Gubesi, Alfe Menashe (IL); Elran Ahronee, Alfe Menashe (IL); Gal Sont, Alfe Menashe (IL)

(21) Appl. No.: 14/055,021

(22) Filed: Oct. 16, 2013

(51) Int. Cl. H04N 21/234; H04H 60/33; G06Q 30/02; H04H 60/40; H04N 21/439; H04N 21/442; H04N 21/458; H04N 21/81; H04N 21/233; G06F 3/01; H04N 21/262

(52) U.S. Cl. CPC H04N 21/23424; G06F 3/017; H04H 60/33; G06Q 30/0269; H04H 60/40; H04N 21/26241; H04N 21/44218; H04N 21/458; H04N 21/812; H04N 21/233; H04N 21/439
USPC 725/12

(57) ABSTRACT

An apparatus arranged to insert accompanying information into a multimedia signal, the apparatus constituted of: a multimedia receiver; a point of interest (POI) identifier arranged to identify a POI in the received multimedia signal responsive to content of the received multimedia signal; an inserter arranged to insert accompanying information into the received multimedia signal responsive to an output of the POI identifier; an output device arranged to transmit the output of the inserter to a display device, the identification, insertion and output being contemporaneous with the receiving; a server; a user gesture signal receiver arranged to receive a signal responsive to a user gesture; and a communication device, wherein the inserted accompanying information encourages a user to perform a gesture with a device in communication with the user gesture signal receiver, and wherein the communication device is arranged to transmit the received signal responsive to the user gesture.

### CROSS REFERENCE TO RELATED APPLICATIONS

This application is a continuation in part of PCT application S/N PCT/IL2013/050317, published on Oct. 10, 2013 as WO 2013/150539, titled “METHOD AND APPARATUS FOR INSERTING INFORMATION INTO MULTIMEDIA DATA”, which claims priority from U.S. provisional patent application Ser. No. 61/619,945 of filing date Apr. 4, 2012 and of the same title, the entire contents of each of which is incorporated herein by reference. This application further claims priority from U.S. provisional patent application 61/714,787 of filing date Oct. 17, 2012, titled “METHOD AND APPARATUS FOR IDENTIFYING POINT OF INTEREST AND INSERT ACCOMPANYING INFORMATION INTO A MULTIMEDIA SIGNAL”, the entire contents of which are incorporated herein by reference.

### BACKGROUND OF THE INVENTION

The invention relates generally to the field of video data streams and in particular to a method and apparatus for identifying a point of interest in a multimedia signal and inserting information into the video data stream responsive to the identified point of interest.

Video entertainment, such as TV shows and home viewed movies, has been very popular for several decades. In recent years, with the advancement of transmission technologies, particularly satellite and cable broadcast technologies, and the development of the Internet, consumers have been exposed to a wide variety of video entertainment sources from all over the world. Such various broadcast media ideally presents numerous commercial opportunities, which are not fully taken into account. For example, it would be desirous to indentify particular points of interest in a large plurality of multimedia programs, and post in various markets appropriate advertising. Such advertisement is ideally tightly focused, based on consumer preference, local geography and demographics. Unfortunately, based on present broadcast technologies such targeted advertising is simply not feasible.

### SUMMARY OF THE INVENTION

Accordingly, it is a principal object of the present invention to overcome at least some of the disadvantages of present and prior art methods of inserting display information into a multimedia signal. This is accomplished in certain embodiments by providing an apparatus arranged to receive the multimedia signal, identify a point of interest in the multimedia signal, insert accompanying information into the multimedia signal responsive to the identified point of interest, and output the combined multimedia signal to a display device the identification, insertion and output being contemporaneous with the receiving of the multimedia signal. In one embodiment, the apparatus further comprises a server; a user gesture signal receiver arranged to receive a signal responsive to a user gesture; and a communication device in communication with the server and the user gesture signal receiver, wherein the inserted accompanying information encourages a user to perform a gesture with at least one device in communication with the user gesture signal receiver, and wherein the communication device is arranged to transmit the received signal responsive to the user gesture to the server.

In one embodiment, the apparatus further provides a communication device arranged to provide communication with a server. Preferably, the server is in communication with a relational database having a point of interest identifier field, a multimedia program identifier field and a classifier for each point of interest. Responsive to the classifier, various advertisement, or associated content, may be advantageously supplied, responsive to user information.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a high level block diagram of a first embodiment of an apparatus arranged to identity a point of interest and insert accompanying information into a received multimedia signal, according to certain embodiments;

FIG. 2 illustrates a high level block diagram of a second embodiment of an apparatus arranged to identity a point of interest and insert accompanying information into a received multimedia signal according to certain embodiments, wherein the user device is in communication with a server;

FIG. 3 illustrates a high level block diagram of a system comprising a server in communication with a database, according to certain embodiments;

FIG. 4 illustrates certain categories of information in the database of FIG. 3;

FIG. 5 illustrates a high level flow chart of the operation of any of the apparatuses of FIGS. 1-3 according to any exemplary embodiment; and

FIG. 6 illustrates a high level flow chart of the operation of any of the apparatuses of FIGS. 1-3 according to any exemplary embodiment wherein a user responsive is encouraged.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The term point of interest (POI), as used herein, is meant to include any particular point, scene, or audio portion, of a multimedia signal for which a display is desired. For example, a POI may include a particular pre-identified scene of a movie for which a particular advertisement type may be advantageous.

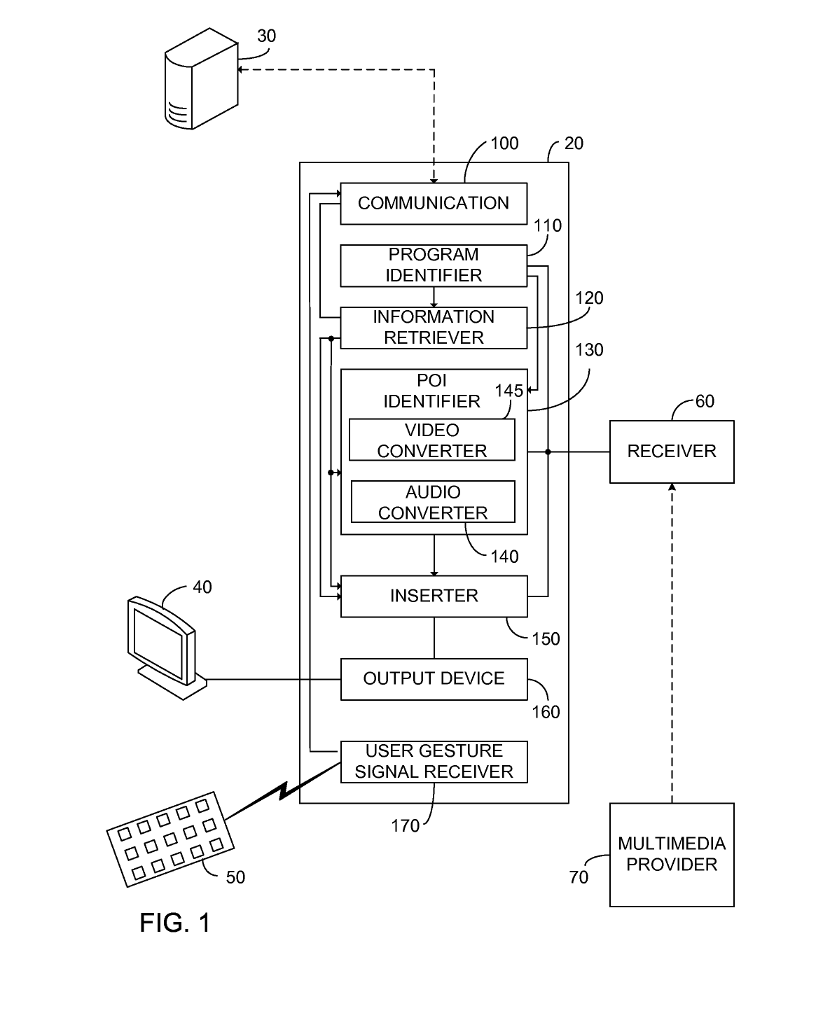

FIG. 1 illustrates a high level block diagram of an apparatus 10 arranged to identify a point of interest in a received multimedia signal and insert accompanying information into the received multimedia signal. Apparatus 10 comprises: a local box 20; an optional server 30; a display device 40; and an optional user device 50; a multimedia receiver 60; and an optional multimedia provider 70. Local box 20 comprises: a communication device 100; a program identifier 110; an information retriever 120; a POI identifier 130 comprising an optional audio converter 140 and optional video converter 145; an inserter 150; an output device 160; and an optional user gesture signal retriever 170. Local box, and/or multimedia receiver 60, may be provided integrated within display device 40 without exceeding the scope.

Each of communication device 100; program identifier 110; information retriever 120; POI identifier 130; audio converter 140; video converter 145; inserter 150; output device 160; and optional user gesture signal retriever 170 may be instituted in special purpose hardware, or in a non-transitory computer readable medium containing instructions to cause a processor to perform the function as described herein.

Optional server 30 is in bi-directional communication with communication device 100, preferably over a network, such as the Internet. Multimedia receiver 60 is in communication with multimedia provider 70, and is arranged to receive there from a multimedia signal, typically comprising a plurality of channels, and comprising various POIs. The output of multimedia receiver 60 is coupled respectively to the inputs of POI identifier 130, program identifier 110, and inserter 120.

Communication device 100 is in communication with information retriever 120, with POI identifier 120 and with inserter 150. User gesture signal receiver 170 is further in communication with communication device 100. User signal receiver 170 is in communication with user device 50, preferably in wireless communication therewith. Program identifier 110 is in communication with information retriever 120, and the output of information retriever 120 is fed to an input of inserter 150 and optionally to POI identifier 130. The output of POI identifier 130 is fed to an input of inserter 150, and the output of inserter 150 is fed to the input of output device 160. The output of output device 160 is fed to display device 40.

Preferably, prior to operation, a user of local box 20 registers with server 30, providing user information, and address information. Such information may include demographic information, preferences, geographic locale information, and age information, without limitation. Such information may be alternately gleaned from third party data. Advantageously, server 30 comprises a plurality of indexed accompanying information records and is in one embodiment arranged to download to inserter 150 and POI identifier 130, POI identities, and accompanying information, targeted responsive to the registration information. Alternately, user locale information is derived from the user IP address associated with local box 20, which is preferably connected to a network, such as the Internet. Socioeconomic information may be interpreted from the derived locale information to determine the appropriate offerings for the user associated with local box 20.

In operation, receiver 60 is arranged to select a particular channel provided by multimedia provider 70 and provides the multimedia signal to local box 20, particularly POI identifier 130, program identifier 110 and inserter 150. POI identifier 130 is arranged to identify a POI in the received multimedia signal responsive to content of the received multimedia signal from receiver 60. Upon identification of a POI in the received multimedia signal, POI identifier 130 transmits a signal to inserter 150, and responsive to the signal from POI identifier 130 inserter 150 is arranged to insert accompanying information into the received multimedia signal. In one embodiment, the accompanying information replaces the received multimedia signal, and inserter 150 thus transfers to output device 160 the accompanying information. Output device 160 is arranged to output the received signal from inserter 150 in a format for used with display device 40. In certain embodiments, output device 160 is contained within inserter 150, which is thus arranged to output a signal compatible with the input of display device 40. In another embodiment the accompanying information is overlaid over a portion of the multimedia signal received from receiver 60, and inserter 150 thus outputs a combined signal to output device 160. Preferably, replacement or overlay is responsive to the particular POI identified by POI identifier 130, as will be described further below. Advantageously, the POI identification of identifier 130 and the accompanying information insertion of inserter 150 is contemporaneous with the receiving of the multimedia signal, i.e. the identification and insertion is done “on the fly”, thereby allowing for accompanying information insertion without delaying the real time display of the multimedia signal. In one embodiment, the accompanying information comprises an advertisement.

In one embodiment, POI identifiers are downloaded and stored within local box 20, such as within a memory portion of POI identifier 130 (not shown). In such an embodiment, preferably a matching plurality of accompanying information is stored within a memory portion of inserter 150. Preferably, each of the accompanying information indicates as to whether it is an overlay or a replacement, and the output of POI identifier 130 further comprises identifying information regarding the POI identified to enable inserter 150 to insert the respective accompanying information.

In the event that no POI has been identified by POI identifier 130, inserter 150 is in one embodiment arranged to pass the received multimedia signal from receiver 60 to output device 160 without interference. In another embodiment, in the event that no POI has been identified by POI identifier 130, inserter 150 is arranged to pass the received multimedia signal with additional information. Optionally, in such a case, inserter 150 passes the received multimedia signal with an identifying watermark overlay.

In one embodiment, the received multimedia signal comprises a flag indicative of the POI. In such an embodiment POI identifier 130 is responsive to the flag. Preferably, the flag comprises an identifier of the accompanying information to be inserted, and in such an embodiment POI identifier 130 is further arranged to retriever the identifier of the accompanying information to be inserted from the incoming received multimedia signal, and transmit the retrieved identifier to inserter 150. Inserter 150 is arranged to insert the accompanying information, selected responsive to the retrieved identifier. Preferably, the accompanying information is supplied, and regularly updated, via communication device 100 from server 30 in cooperation with information retriever 120.

In one embodiment, POI identifier 130 is responsive to subtitle information accompanying the received multimedia signal. In one non-limiting embodiment, POI identifier 130 identifies a predetermined text string in the subtitle information, and responsive thereto signals inserter 150 to insert the respective accompanying information into the received multimedia signal.

In one embodiment, audio converter 140 is arranged to convert the audio portion of the received multimedia signal to a digital signal, and compare the converted audio portion to a predetermined audio portion. Upon identification of the predetermined audio portion in the received multimedia signal, POI identifier 130, responsive to audio converter 140, is arranged to signal inserter 150 to insert the respective accompanying information into the received multimedia signal.

In one embodiment, video converter 145 is arranged to search for a predetermined image, scene, or action pattern, within the received multimedia signal. In one embodiment video converter 145 renders individual frames of the received multimedia signal, and further processes the rendered frames via an image recognition engine. In one particular embodiment, the image recognition engine utilizes a face recognition algorithm in cooperation with stored image information on a local memory of POI identifier 130. Upon identification of the predetermined image, scene, or action pattern, within the received multimedia signal, POI identifier 130, responsive to video converter 145, is arranged to signal inserter 150 to insert the respective accompanying information into the received multimedia signal.

In one embodiment, POI identifier 130 is arranged to identify a predetermined temporal point in a received multimedia signal, such as a predetermined time from the beginning of a program of interest. Upon identification of the predetermined temporal point, POI identifier 130 is arranged to signal inserter 150 to insert the respective accompanying information into the received multimedia signal.

In one embodiment, POI identifier 130 is arranged to identify a predetermined point in time, irrespective of the content of the received multimedia signal, or for certain identified multimedia signals. Upon identification of the predetermined point in time, POI identifier 130 is arranged to signal inserter 150 to insert the respective accompanying information into the received multimedia signal.

Program identifier 110 is arranged to provide identifying information regarding the received multimedia signal, and may be optionally in communication with POI identifier 130 (communication link not shown) thus enabling POI identifier 130 to identify the multimedia signal. In one embodiment, POI identifier 130 is arranged to identify the program responsive to a watermark, or other information, in the received multimedia signal, irrespective of input from program identifier 110.

In one embodiment, program identifier 110 is arranged to obtain identifying information regarding the received multimedia signal, and output the obtained identifying information to information retriever 120. In one embodiment, the identifying information parameters are extracted from a text layer of the received video data stream. In one embodiment, wherein the received multimedia data stream comprises embedded electronic program guide (EPG) information, the extracted identifying information parameters are responsive to at least a portion of the EPG information. In one embodiment, the extracted identifying parameters are compared to identifying parameters associated with each of the stored accompanying records to find the corresponding accompanying record. In another embodiment, a function of the extracted identifying parameters is compared to identifying parameters associated with each of a plurality of stored records on a memory portion of program identifier 110 to find the corresponding stored record. In one further embodiment, the function is a translation of the extracted identifying parameters. In one embodiment, program identifier 110 adjusts the extracted identifying parameters according to a data cleansing algorithm such that the extracted identifying parameters may be compared to identifying parameters associated with the stored records. In one further embodiment, the data cleansing algorithm is utilized in conjunction with a stored list of titles of video presentations in a plurality of languages. In one particular embodiment, the data cleansing algorithm is arranged to remove non-relevant data, such as data added to a title.

Information retriever 120, responsive to the obtained identifying information from program identifier 110, is arranged to communicate with server 30 via communication device 100, and retrieve from server 30 information associated with the obtained identifying information, particularly POI information and accompanying information to be inserted into the multimedia signal.

User device 50 is in communication with user gesture signal receiver 170. In one non-limiting embodiment, user device 50 is a remote control in optical communication with user gesture signal receiver 170. Optionally, the inserted accompanying information encourages a user to provide a gesture in cooperation with user device 50, such as the depression of a predetermined input key. User device 50, responsive to the user gesture is arranged to transmit a signal to user gesture signal receiver 170 indicative of the user gesture. User gesture signal receiver 170 transmits information regarding the received signal to server 30 via communication device 100.

As described below, responsive to the user gesture, various activities or actions may be performed by server 30. In particular, server 30 may arrange for a display of premium information, may provide a special offer, or arrange for sale of goods or services, advantageously responsive to the actual received multimedia signal. Further advantageously, the accompanying information is particularly relevant to the user as it is based on user information, as described above.

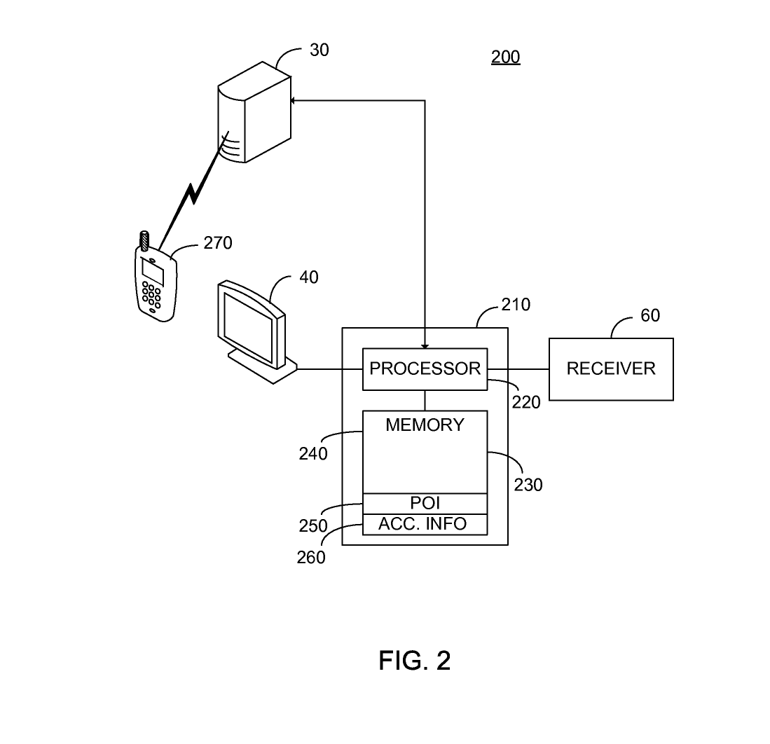

FIG. 2 illustrates a high level block diagram of a second embodiment of an apparatus 200 arranged to identity a point of interest and insert accompanying information into a received multimedia signal according to certain embodiments, wherein a user device 270 is in communication with a server 30. User device 270 is illustrated as a user mobile device, such as a smart telephone, however this is not meant to be limiting in any way. Apparatus 200 further comprises a receiver 60, a local box 210 and a display device 40. Local box 210, and/or receiver 60, may be provided integrated within display device 40 without exceeding the scope. Local box 210 comprises a processor 220, and a memory 230 in communication with processor 220. Memory 230 comprises a general purpose memory portion 240 arranged to store computer readable instructions, which are non-transitory signals, readable by processor 220, which when read by processor 220 instruct processor 220 to perform the various functionalities described in FIG. 1 in relation to local box 20. Memory 230 further comprises a POI memory portion 250 arranged to store identifying information for identification of a POI in the received multimedia signal. Memory 230 further comprises an accompanying information memory portion 260 arranged to store accompanying information for insertion by inserter 150. Preferably, for each POI a particular accompanying information is stored.

In operation, apparatus 200 is in all respects identical with the operation of apparatus 20, except that user gesture signal receiver 170 is not required. Instead, user device 270 sends signals directly to server 30. In one embodiment, inserter 150 thus outputs onto display 40 an optically readable code which is read by user device 270, and optionally responsive to a user gesture a communication link with server 30 is established. Such a communication link, responsive to the optically readable code, comprises the required information to enable the initialization of a transaction between server 30 and user device 270. There is no requirement that the user device 270 read an optically readable code, and any form of communication between user device 270 and local box 200 may be instituted without exceeding the scope.

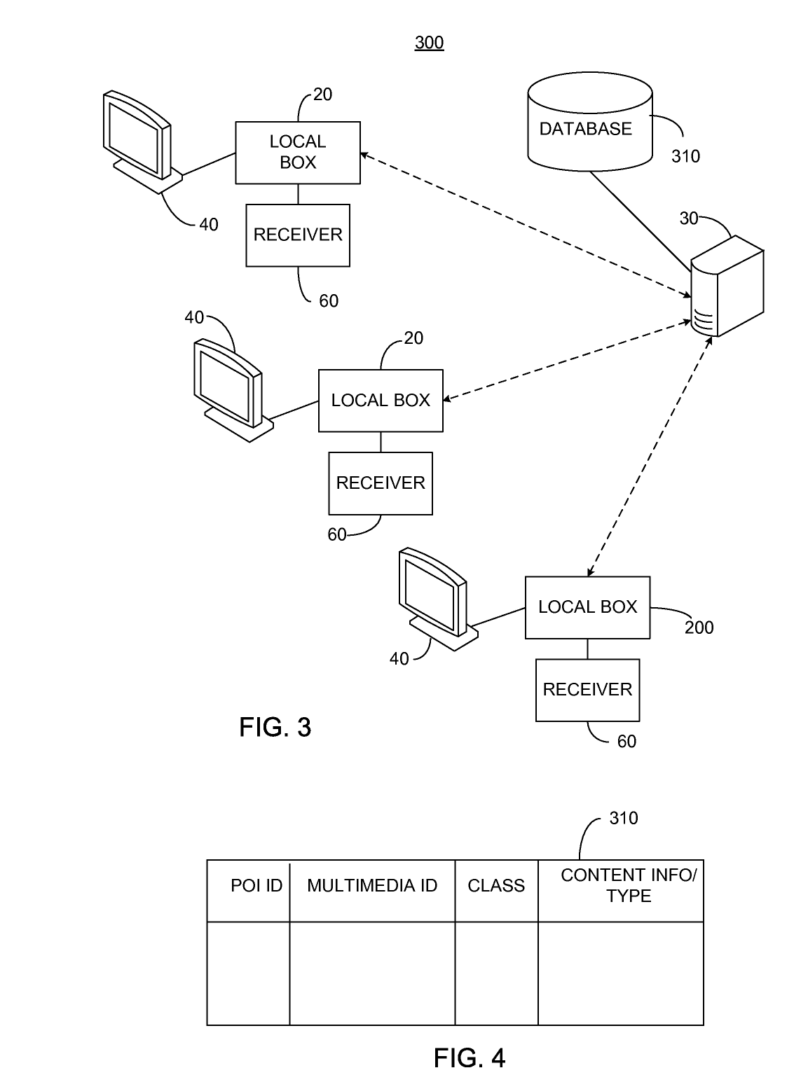

FIG. 3 illustrates a high level block diagram of a system 300 comprising a server 30 in communication with a database, and further comprising a plurality of local boxes 20, 200, according to certain embodiments. Each local box 20, 200 is in communication with a respective receiver 60, and a respective display device 40 as described above, and in communication with server 30. Local box 20, 200 and/or multimedia receiver 60, may be provided integrated within the respective display device 40 without exceeding the scope. Server 30 is in communication with database 310, which has stored thereon information regarding the registered user of each local box 20, 200. Additionally, referring to FIG. 4, database 310 has stored thereon relational information regarding: an identifier of each POI; an identifier of each multimedia signal, i.e. program; an identifier of the classification for the POI; and content information and type. Responsive to the POI database, potential advertisers may select and design accompanying information to be displayed, and particularly target same to certain user profiles. Server 30 is arranged to transmit the appropriate POI identifying information and accompanying information to each local box 20, 200 in accordance with user preferences.

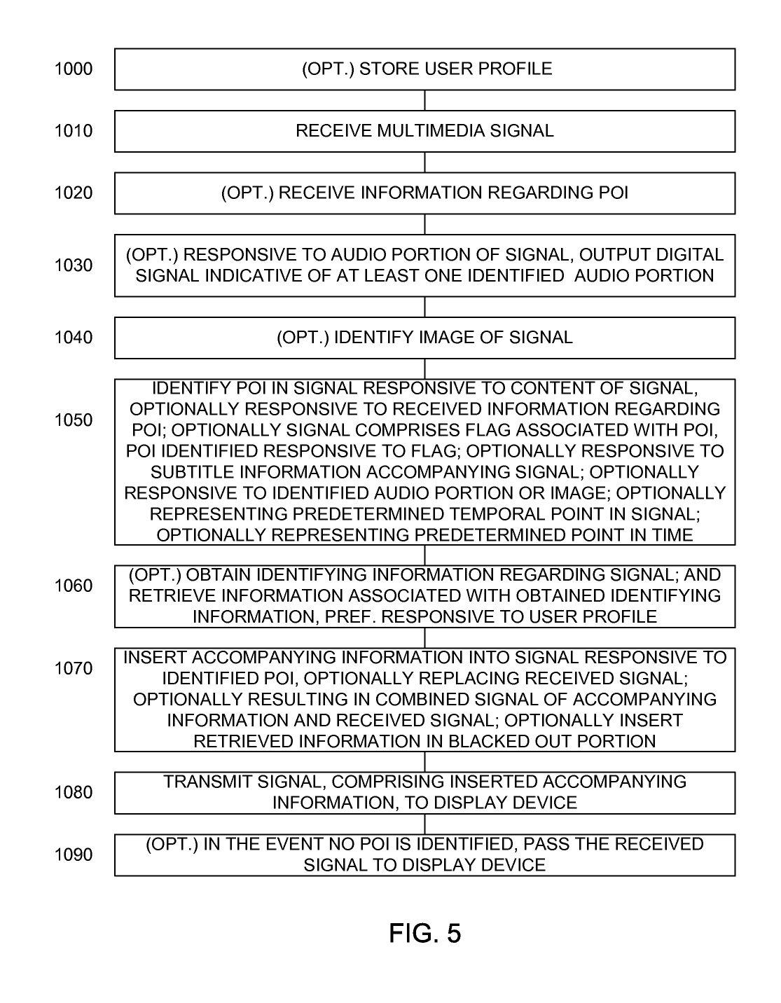

FIG. 5 illustrates a high level flow chart of the operation of any of apparatuses 10, 200 and 300 of FIGS. 1-3 according to any exemplary embodiment. In stage 1000, a user registers with server 30, and a user profile is stored. As described above, stage 1000 is not required and the information may be gleaned responsive to IP information. In stage 1010, a multimedia signal is received, such as by receiver 60. In stage 1020, information is received regarding the various POIs in the multimedia signal. In one embodiment, the POIs are received responsive to information regarding the received signal identified by program identifier 110.

In optional stage 1030, wherein the POI is responsive to an audio portion of the multimedia signal, responsive to an audio portion of the multimedia signal, a digital signal is output indicative of at least one identified audio portion, as described above in relation to audio converter 140.

In optional stage 1040, an image, scene of sequence in the multimedia signal is identified as a POI.

In stage 1050, the POI in the multimedia signal is identified, responsive to content in the signal. Optionally, the POI is responsive received POI information from server 30. Optionally, the POI is identified responsive to a flag embedded in the received multimedia signal. Optionally, the POI is identified responsive to subtitle information in the received multimedia signal. Optionally, the POI is identified responsive to an identified audio portion as described above in relation to stage 1030. Optionally, the POI is identified responsive to an identified image, scene or sequence as described above in relation to stage 1040. Optionally, the POI is identified responsive to a predetermined temporal point in the multimedia signal. Optionally, the POI is identified responsive to a predetermined point in time.

In optional stage 1060, identifying information regarding the received multimedia signal is retrieved, preferably from the multimedia signal. Further optionally, information is retrieved regarding the accompanying information to be inserted in the multimedia signal. Preferably the accompanying information is responsive to the user associated information of stage 1000.

In stage 1070, accompanying information is inserted into the received multimedia signal responsive to the identified POI of stage 1050. Optionally, the insertion replaces the received multimedia signal of stage 1010. Optionally, the accompanying information is combined into the received multimedia signal resulting in a combined signal. Optionally, the accompanying information is inserted in a blacked out portion of the screen. Optionally, the accompanying information comprises an advertisement.

In stage 1080, the signal is transmitted to a display device comprising the inserted accompanying information. In optional stage 1090, in the event that no POI has been identified, the received multimedia signal is passed undisturbed to the display device.

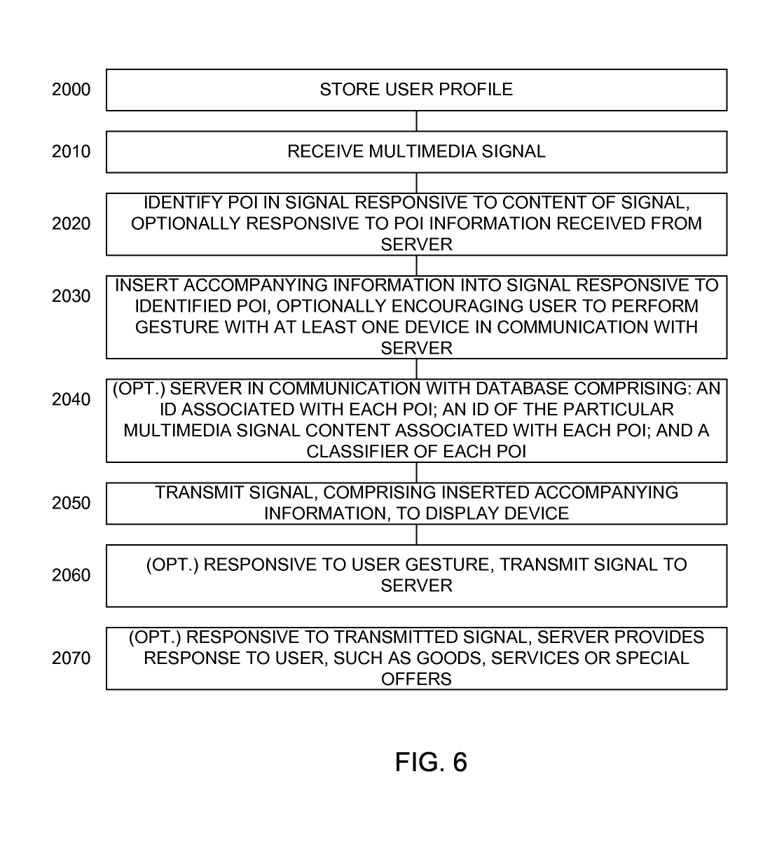

FIG. 6 illustrates a high level flow chart of the operation of any of apparatuses 10, 200 and 300 of FIGS. 1-3 according to any exemplary embodiment, wherein a user input is encouraged. In stage 2000, a user registers with server 30, and a user profile is stored. In stage 2010, a multimedia signal is received, such as by receiver 60.

In stage 2020, a POI in the received multimedia signal of stage 2020 is identified responsive to the content of the received multimedia signal, and optionally responsive to POI information received from the server. The POI information is preferably responsive to the user profile of stage 2000.

In stage 2030, accompanying information is inserted into the received multimedia signal responsive to the identified POI, optionally encouraging the user to perform a gesture with an input device of a user device which is in communication with the server, either directly as described above in relation to apparatus 200 or via the local box as described above in relation to apparatus 10. Optionally, the accompanying information comprises an advertisement.

In optional stage 2040, the server is in communication with a relational database comprising at least: an ID associated with each POI; an ID of the particular multimedia signal content associated with each POI; and a classifier of each POI.

In stage 2050, the multimedia signal, combined with the accompanying information, or replaced with the accompanying information, is output to the display device.

In optional stage 2060, responsive to user gesture in cooperation with an input device of the user device, the user response is communicated to the server. The response communicated to the server is related to the present POI which triggered same, either due to information in the local box 20, or responsive to information communicated between local box 300 and server 30 regarding program information. As such, the user gesture is indicative of a real interest in performing a transaction, and as such has increased utility and value.

In optional stage 2070, server 30 responds to the received indication of optional stage 2060. As described below, in certain embodiments the response may in certain embodiments comprise a display of premium information, in certain embodiment the response may result in a sale of goods or services and in certain other embodiments the response may be the provision of a special offer leading to the sale of goods or services.

There are thus various scenarios which may utilize the teachings herein.

In one embodiment, responsive to a flag, or other identifying information in a watched multimedia signal, a POI is identified from a downloaded list of POIs related to the identified multimedia signal. Responsive to the identified POI, accompanying information is inserted into the multimedia signal comprising an offer of interest to the registered user. The offer may further be pushed to a user device, such as a mobile phone.

In another embodiment, accompanying information related to the identified multimedia signal is added onto extended information window, which is in one embodiment a blacked out portion of the display device. The user is offered the ability to select particular premium content from offers related to the present multimedia signal from the extended information window.

In one further embodiment, the POI is an identification of the multimedia signal and current content thereof. In such an embodiment, information may displayed in the extended information window during the run time of the current content, preferably responsive to a user gesture.

In another embodiment, responsive to a key word detected either from the audio portion or from the subtitle records, an offer for a related product or service is displayed on the display device, i.e. the accompanying information is the offer for the related product or service, and a user gesture response is encouraged. Lack of response within a predetermined period results in clearing of the accompanying information from the display.

In another embodiment, responsive to a server notification, and a user profile, a POI is defined as a temporal point in a multimedia signal. An offer is displayed overlaying a portion of the multimedia signal for a predetermined time.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. An apparatus arranged to insert accompanying information into a multimedia signal, the apparatus comprising:
a multimedia receiver arranged to receive the multimedia signal;
a point of interest identifier in communication with the received multimedia signal and arranged to identify a point of interest in the received multimedia signal responsive to content of the received multimedia signal;
an inserter arranged to insert accompanying information into the received multimedia signal responsive to an output of said point of interest identifier;
an output device arranged to transmit the output of said inserter to a display device, said identification, insertion and output being contemporaneous with said receiving;
a server;
a user gesture signal receiver arranged to receive a signal responsive to a user gesture; and
a communication device in communication with said server and said user gesture signal receiver,
wherein said inserted accompanying information encourages a user to perform a gesture with at least one device in communication with said user gesture signal receiver, and wherein said communication device is arranged to transmit said received signal responsive to the user gesture to said server.

2. The apparatus of claim 1, wherein said insertion of said accompanying information by said inserter replaces the received multimedia signal.

3. The apparatus of claim 1, wherein said insertion of said accompanying information by said inserter results in a combined signal of said accompanying information and the received multimedia signal output to the display device by said output device.

4. The apparatus of claim 1, further comprising a communication device arranged to receive information regarding said point of interest, said point of interest identifier responsive to said received information.

5. The apparatus of claim 1, wherein said inserter is further arranged to alternately pass said received multimedia signal.

6. The apparatus of claim 1, wherein the content of the received multimedia signal comprises a flag associated with the point of interest, and wherein said point of interest identifier is arranged to identify the flag, thereby identifying the point of interest in the received multimedia signal.

7. The apparatus of claim 1, wherein said point of interest identifier is responsive to subtitle information accompanying the received multimedia signal.

8. The apparatus of claim 1, wherein said point of interest identifier comprises an audio converter responsive to an audio portion of the received multimedia signal, said audio converter arranged to output a digital signal indicative of at least one identified audio portion, wherein said identification of the point of interest in the received multimedia signal is responsive to the identified audio portion.

9. The apparatus of claim 1, wherein said point of interest identifier is further arranged to identify an image of the received multimedia signal, wherein said identification of the point of interest in the received multimedia signal is responsive to said identified image.

10. The apparatus of claim 1, wherein said identified point of interest in the received multimedia signal represents a predetermined temporal point in the received multimedia signal.

11. The apparatus of claim 1, wherein said identified point of interest in the received multimedia signal represents a predetermined point in time.

12. The apparatus of claim 1, wherein said server comprises an indexed plurality of accompanying information.

13. The apparatus of claim 1, further comprising a database in communication with said server, said database comprising:
an identifier associated with each point of interest;
an identifier of the particular multimedia signal content associated with each point of interest; and
a classifier of each point of interest.

14. The apparatus of claim 1, wherein said communication device is further arranged to perform communication between said server and said point of interest identifier, wherein said multimedia receiver, said point of interest identifier, said inserter, said output device and said communication device are collocated with the display device, and said server is remote from said display device, wherein said communication device is arranged to receive information from said server regarding said point of interest, said point of interest identifier responsive to said received information.

15. The apparatus according to claim 14, further comprising a user device in communication with said user gesture signal receiver, wherein said user device is arranged responsive to a user gesture to transmit the signal responsive to the user gesture to be received by said user gesture signal receiver.

16. The apparatus according to claim 14, further comprising:
a program identifier arranged to obtain identifying information regarding said received multimedia signal; and
an information retriever in communication with said program identifier, said server via said communication device, and said inserter, said information retriever arranged to retrieve from said server via said communication device information associated with the obtained identifying information,
wherein said inserter is further arranged to insert the retrieved information into the received multimedia signal.

17. The apparatus according to claim 11, further comprising a mobile device in communication with the user gesture signal receiver, wherein said mobile device is arranged responsive to a user gesture to communicate with the server responsive to the accompanying information.

18. A method of inserting accompanying information into a multimedia signal, the method comprising:
receiving the multimedia signal;
identifying a point of interest in the received multimedia signal responsive to content of the received multimedia signal;
inserting accompanying information into said received multimedia signal responsive to said identified point of interest;
transmitting said received multimedia signal comprising said inserted accompanying information to a display device, said identifying, inserting and transmitting being contemporaneous with said receiving;
providing a server;
providing a user gesture signal receiver; and
providing a communication device in communication with said provided server and said provided user gesture signal receiver,
wherein said accompanying information encourages a user to perform a gesture with a user device in communication with said provided user gesture signal receiver, said user device transmitting a signal to said user gesture signal receiver indicative of said user gesture, said user gesture signal receiver transmitting information to said server via said provided communication device regarding said transmitted signal.

19. The method of claim 18, wherein said insertion of said accompanying information replaces said received multimedia signal.

20. The method of claim 18, wherein said insertion of said accompanying information results in a combined signal of said accompanying information and said received multimedia signal.

21. The method of claim 18, further comprising receiving information regarding the point of interest, said identifying the point of interest responsive to said received information.

22. The method of claim 18, further comprising, in the event that no point of interest is identified, passing said received multimedia signal.

23. The method of claim 18, wherein the content of the received multimedia signal comprises a flag associated with the point of interest, the method further comprising identifying the flag, thereby identifying the point of interest in said received multimedia signal.

24. The method of claim 18, wherein said identifying the point of interest is responsive to subtitle information accompanying said received multimedia signal.

25. The method of claim 18, further comprising:
identifying an audio portion of said received multimedia signal; and
outputting a digital signal indicative of said identified at least one identified audio portion,
wherein said identifying the point of interest is responsive to the identified audio portion.

26. The method of claim 18, further comprising identifying an image of the received multimedia signal,
wherein said identifying the point of interest is responsive to said identified image.

27. The method of claim 18, wherein said identified point of interest in said received multimedia signal represents a predetermined temporal point in said received multimedia signal.

28. The method of claim 18, wherein said identified point of interest in said received multimedia signal represents a predetermined point in time.

29. The method of claim 18, wherein said provided server comprises a plurality of indexed accompanying information.

30. The method of claim 18, further comprising providing a database in communication with said provided server, said provided database comprising:
an identifier associated with each point of interest;
an identifier of the particular multimedia signal content associated with each point of interest; and
a classifier of each point of interest.

31. The method of claim 30, further comprising:
obtaining identifying information regarding said received multimedia signal;
retrieving from said provided server information associated with said obtained identifying information; and
inserting said retrieved information into said received multimedia signal.

32. The method of claim 31, further comprising:
providing a user device in communication with said provided server;
receiving a user gesture at a mobile device; and
responsive to said received user gesture, transmitting a message responsive to said inserted accompanying information to said provided server.

33. The method of claim 18, further comprising:
obtaining identifying information regarding said received multimedia signal; and
retrieving from said provided server via said provided communication device information associated with the obtained identifying information; and
inserting the retrieved information into the received multimedia signal.
